(19) United States
(12) Patent Application Publication
(10) Pub. No.: US 2021/0374702 A1
(43) Pub. Date: Dec. 2, 2021

(54) COMPUTER READABLE RECORDING MEDIUM, SETTLEMENT SYSTEM, AND SETTLEMENT SERVER

(71) Applicant: TOYOTA JIDOSHA KABUSHIKI KAISHA, Toyota-shi (JP)

(72) Inventors: Tomokazu MAYA, Nagoya-shi (JP); Naoki YAMAMURO, Nagoya-shi (JP); Yuki NAKATANI, Tokyo-to (JP); Kosuke MIYAKE, Tokyo-to (JP); Soushi MIZUNO, Tokyo-to (JP); Yasushi FURUHATA, Kodaira-shi (JP); Masataka NARITA, Tokyo-to (JP); Yasuhiro TAKEHARA, Nagoya-shi (JP)

(73) Assignee: TOYOTA JIDOSHA KABUSHIKI KAISHA, Toyota-shi (JP)

(21) Appl. No.: 17/240,183

(22) Filed: Apr. 26, 2021

(30) Foreign Application Priority Data
May 29, 2020 (JP) 2020-094765

(51) Int. Cl. G06Q 20/20; G06F 3/0482; G01C 21/36

(52) U.S. Cl. CPC G06Q 20/202; G06Q 20/363; G01C 21/3682; G06F 3/0482

(57) ABSTRACT

Provided is a non-transitory computer-readable recording medium on which an executable program is recorded, the program causing a processor of a computer to execute: extracting target facilities located on a route to a destination; and outputting, to a display, a target facility that allows use of a settlement method selected by user's input from among the extracted target facilities.

The present application claims priority to and incorporates by reference the entire contents of Japanese Patent Application No. 2020-094765 filed in Japan on May 29, 2020.

### BACKGROUND

The present disclosure relates to a computer readable recording medium, a settlement system, and a settlement server.

JP 2002-243479 A discloses a technique of displaying a shop that may be used in a drive-through located in the vicinity of the current position of a vehicle.

### SUMMARY

There is a need for enhanced convenience of wallet systems capable of using a plurality of settlement methods.

According to one aspect of the present disclosure, there is provided a non-transitory computer-readable recording medium on which an executable program is recorded, the program causing a processor of a computer to execute: extracting target facilities located on a route to a destination; and outputting, to a display, a target facility that allows use of a settlement method selected by user's input from among the extracted target facilities.

### BRIEF DESCRIPTION OF THE DRAWINGS

FIG. 1 is a diagram schematically illustrating a configuration of a wallet system including a settlement server according to an embodiment;

FIG. 2 is a block diagram illustrating details of individual components of a wallet system including a settlement server according to the embodiment;

FIG. 3 is a diagram schematically illustrating a relationship between a wallet and a settlement method in a wallet system including a settlement server according to the embodiment;

FIG. 4 is a diagram illustrating an example in which a plurality of settlement methods is displayed as a list on an operation/display unit of a user terminal in a settlement server according to the embodiment; and

FIG. 5 is a diagram illustrating an example in which a target facility is displayed on an operation/display unit of a user terminal in a settlement server according to the embodiment.

### DETAILED DESCRIPTION

A computer readable recording medium storing a settlement program, a settlement system, and a settlement server according to an embodiment of the present disclosure will be described with reference to the drawings. Note that the constituent elements in the following embodiment include those that may be easily replaced by those skilled in the art, or those that are substantially the same.

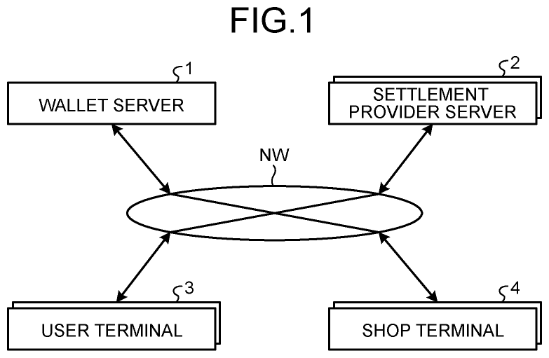

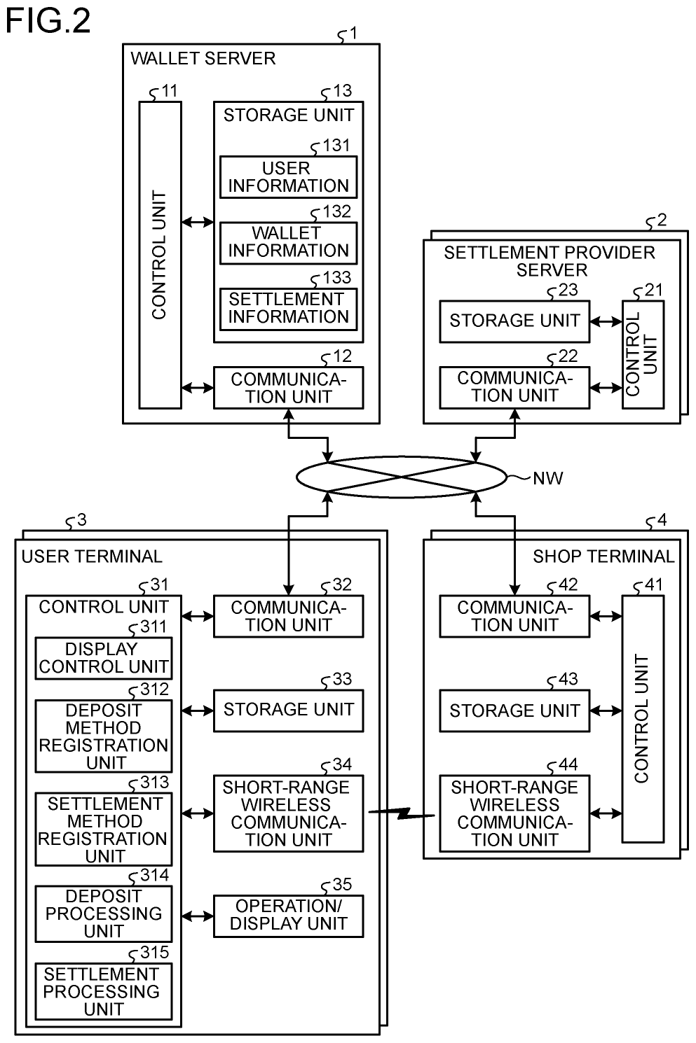

Configurations of a wallet system according to the embodiment will be described with reference to FIGS. 1 and 2. As illustrated in FIG. 1, the wallet system includes a wallet server 1, a settlement provider server 2, a user terminal 3, and a shop terminal 4.

The wallet server 1, the settlement provider server 2, the user terminal 3 and the shop terminal 4 are communicable with each other through a network NW. The network NW is composed of, for example, an Internet network, a mobile phone network, or the like.

The wallet server 1 is a server for comprehensively managing a wallet system in which a plurality of settlement methods is registered, and is managed by a wallet system administrator. Alternately, however, the wallet server 1 may be a settlement server in which one settlement method is registered. As illustrated in FIG. 2, the wallet server 1 includes a control unit (first processor) 11, a communication unit 12, and a storage unit 13.

The control unit 11 is specifically equipped with: a processor including a central processing unit (CPU), a digital signal processor (DSP), and a field-programmable gate array (FPGA); and memory (main storage unit) including random access memory (RAM) and read only memory (ROM).

The control unit 11 loads a program stored in the storage unit 13 into the work area of the main storage unit and executes the program. Through execution of the program, the control unit 11 controls individual components, thereby actualizing a function that matches a predetermined purpose.

The communication unit 12 is constituted with, for example, a local area network (LAN) interface board, a wireless communication circuit for wireless communication, or the like. The communication unit 12 is connected to the network NW such as the Internet which is a public communication network. The communication unit 12 communicates with the settlement provider server 2, the user terminal 3, and the shop terminal 4 by connecting to the network NW.

The storage unit 13 includes a recording medium such as erasable programmable ROM (EPROM), a hard disk drive (HDD), and a removable medium. Examples of the removable medium include disc recording media such as a universal serial bus (USB) flash drive, a compact disc (CD), a digital versatile disc (DVD), and a Blu-ray (BD; registered trademark). The storage unit 13 may store an operating system (OS), various programs, various tables, various databases, or the like. The storage unit 13 according to the present embodiment stores user information 131, wallet information 132, and settlement information 133 for each of users of the wallet system.

The user information 131 is information related to a user who uses the wallet system. Examples of the user information 131 include information regarding the user who has registered to use the wallet system, such as user ID, password, user name, user contact information (for example, street address, telephone number, email address, etc.), information including usage registration history, and registered settlement method, information regarding other settlement methods registered to deposit to the settlement method, and settlement passcode. The user ID and password among the user information 131 are used for an authentication process such as login to the wallet server 1.

The wallet information 132 is information related a wallet of the wallet system. A wallet is an application that manages virtual deposit/withdrawal using various settlement methods such as credit cards and electronic money. Specifically, the wallet information 132 includes, for example, user ID, a settlement method, an electronic money balance, an electronic money deposit history, an electronic money usage history, or the like.

The settlement information 133 is information related to the settlement of the wallet system. Examples of the settlement information 133 include user ID, a settlement method used for settlement (for example, electronic money payment (non-contact settlement), scan payment, code payment, etc.), and the settlement history.

The settlement provider server 2 is a server for managing user's bank accounts and credit cards and is provided in financial institutions (for example, banks, credit association, credit unions, labor banks, etc.) and credit card companies. The settlement provider server 2 includes a control unit 21, a communication unit 22, and a storage unit 23. The control unit 21, the communication unit 22, and the storage unit 23 are physically similar to the control unit 11, the communication unit 12, and the storage unit 13, respectively.

The storage unit 23 stores account information and credit card information for each of users of the wallet system. Examples of the account information include the user's name, account number, account balance, deposit/withdrawal history, or the like. The credit card information includes, for example, the user's name, credit card number, credit card expiration date, usage limit amount, card usage history, or the like.

The user terminal 3 is a computer terminal used by the user. Examples of the user terminal 3 include smartphones, mobile phones, tablet terminals, wearable computers, personal computers, car navigation systems mounted on vehicles, or the like owned by the user. The user terminal 3 may be any terminal as long as it may exchange information with the wallet server 1.

The user terminal 3 includes a control unit (second processor) 31, a communication unit 32, a storage unit 33, a short-range wireless communication unit 34, and an operation/display unit (display) 35. The control unit 31, the communication unit 32, and the storage unit 33 are physically similar to the control unit 11, the communication unit 12, and the storage unit 13, respectively. Through execution of the program, the control unit 31 functions as a display control unit 311, a deposit method registration unit 312, a settlement method registration unit 313, a deposit processing unit 314, and a settlement processing unit 315.

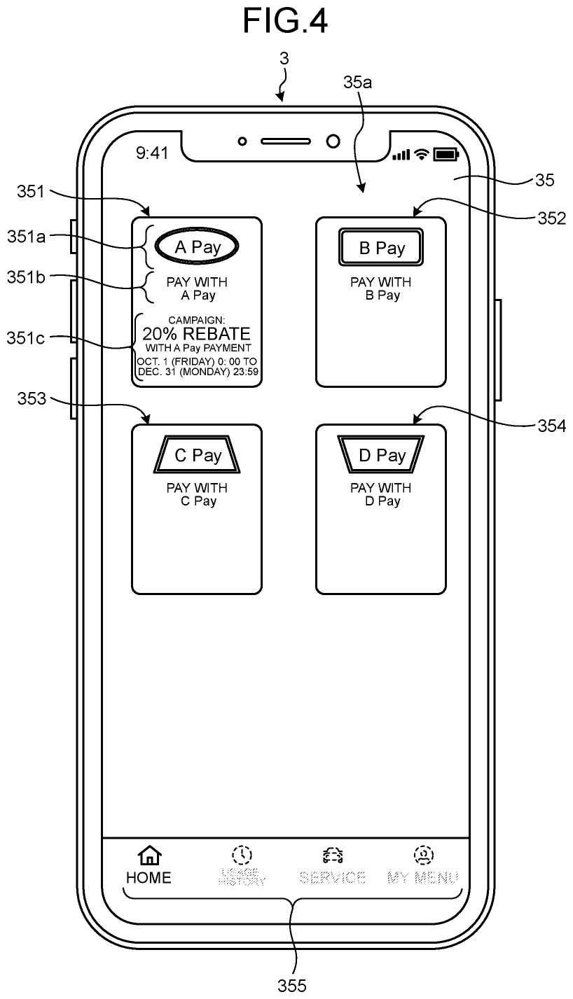

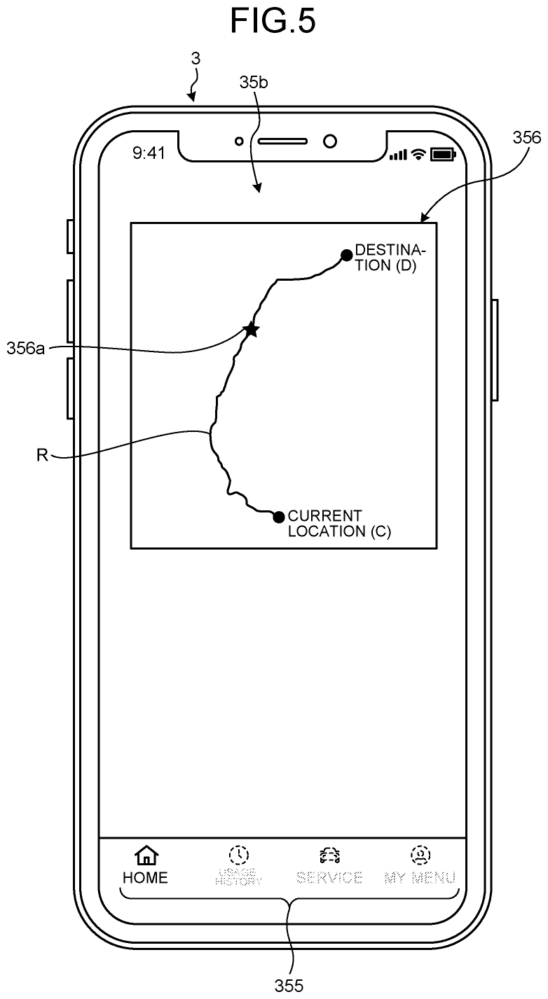

The display control unit 311 controls the content to be displayed on the operation/display unit 35. Based on the user's operation (touch operation, flick operation, or the like), the display control unit 311 displays on the operation/display unit 35, a member registration screen on which the user registers as a member, a login screen used at the time of logging in to the wallet system, a deposit screen used at the time of depositing to the electronic money of the wallet, a settlement method selection screen 35a (refer to FIG. 4) at the time of making a settlement, and a target facility display screen 35b (refer to FIG. 5) for displaying target facilities. In addition, the display control unit 311 causes each of screens to transition based on a user's operation.

The deposit method registration unit 312 registers a deposit method for depositing to the electronic money. Specifically, the deposit method registration unit 312 transmits, to the wallet server 1, a deposit method registration request for asking for the registration of a plurality of different settlement methods (for example, a bank account, a credit card, etc.) operated by a plurality of providers as a method for depositing to the electronic money. Having received the deposit method registration request from the deposit method registration unit 312, the control unit 11 of the wallet server 1 stores the settlement method included in the deposit method registration request onto the storage unit 13 as the user information 131, thereby registering the method as the deposit method.

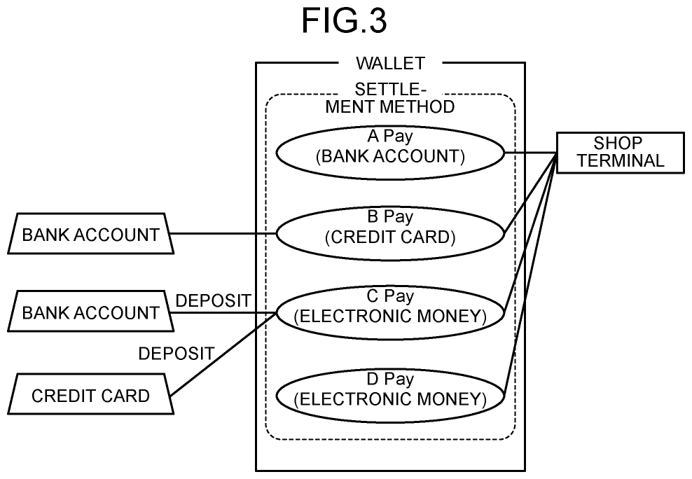

Here, FIG. 3 is a diagram schematically illustrating the relationship between the wallet and the settlement methods in the wallet system. The “settlement method” indicates a payment source (funding source) used at the time of making a settlement. The wallet has registered a plurality of settlement methods such as “A Pay” which is settlement by bank account, “B Pay” which is settlement by credit card, “C Pay” and “D Pay” which are settlement by electronic money, or the like. “A Pay” is a settlement method in which the settlement amount is directly deducted from a bank account. In addition, each of credit cards (“B Pay”) is associated with a bank account, and the usage amount of each of the cards will be deducted from the bank account at a later date. Electronic money (“C Pay”) is associated with a deposit method such as a bank account, a credit card, or the like, being a method for depositing to electronic money, and capable of depositing to the electronic money. In a case where the electronic money (“D Pay”) is a prepaid system in which deposit is made in advance by cash or the like, the electronic money does not have to be associated with the deposit method such as a bank account or a credit card.

By using a settlement method selected from these settlement methods by the user, settlement is performed between the user terminal 3 and the shop terminal 4. Specifically, by holding the user terminal 3 over the shop terminal 4, various settlement methods are executed between the short-range wireless communication unit 34 of the user terminal 3 and a short-range wireless communication unit 44 of the shop terminal 4 described below, including the settlement that is made in a non-contact manner, the settlement that is made by reading a barcode or QR code (registered trademark) displayed on the shop terminal 4 with a camera of the user terminal 3 or the like, or the settlement that is made by reading a barcode or QR code (registered trademark) displayed on the user terminal 3 with a code reader of the shop terminal 4 or the like.

The settlement method registration unit 313 registers various settlement methods. The settlement method registration unit 313 transmits a settlement method registration request for registering the settlement method, to the wallet server 1. Having received the settlement method registration request from the settlement method registration unit 313, the control unit 11 of the wallet server 1 stores the settlement method included in the settlement method registration request, onto the storage unit 13 as user information 131, thereby performing registration of this method as the settlement method.

The deposit processing unit 314 deposits to the electronic money of the wallet. Specifically, the deposit processing unit 314 transmits a deposit request for depositing to electronic money, to the wallet server 1 by a settlement method registered as a deposit method. Having received the deposit request from the deposit processing unit 314, the control unit 11 of the wallet server 1 increases the balance of electronic money in the wallet based on the deposit amount information included in the deposit request. That is, the control unit 11 updates the wallet information 132 stored in the storage unit 13 in accordance with the increase amount in the balance of electronic money in the wallet.

The settlement processing unit 315 executes the settlement using the settlement method selected by the user. Specifically, the settlement processing unit 315 transmits a settlement request to the shop terminal 4 through the short-range wireless communication unit 34 as a settlement method. Alternatively, the settlement processing unit 315 may transmit the settlement request to the shop terminal 4 by reading a barcode or a QR code (registered trademark) displayed on the shop terminal 4 with a camera or the like of the user terminal 3 as a settlement method. Further alternatively, the settlement processing unit 315 may transmit the settlement request to the shop terminal 4 by reading a barcode or a QR code (registered trademark) displayed on the user terminal 3 with a code reader or the like of the shop terminal 4 as a settlement method. The settlement request transmitted from the settlement processing unit 315 to the shop terminal 4 may include or need not include information indicating the settlement amount (hereinafter referred to as “settlement amount information”).

Next, in the case of a settlement using a bank account or a credit card, the settlement processing unit 315 transmits a settlement request for making a settlement using any settlement method to the wallet server 1. Having received the settlement request from the settlement processing unit 315, the control unit 11 of the wallet server 1 transmits the settlement amount information included in the settlement request to the settlement provider server 2.

Furthermore, regarding the settlement processing unit 315 in the case of settlement by electronic money, a control unit 41 of the shop terminal 4 described below transmits a settlement request including settlement amount information to the wallet server 1 via the network NW. Having received the settlement request from the shop terminal 4, the control unit 11 of the wallet server 1 decreases the balance of electronic money in the wallet based on the settlement amount information included in the settlement request. That is, the control unit 11 updates the wallet information 132 and the settlement information 133 stored in the storage unit 13 in accordance with the decrease amount in the balance of electronic money in the wallet.

The storage unit 33 stores various screen data to be displayed on the operation/display unit 35 by the display control unit 311. Furthermore, the storage unit 33 temporarily stores user information 131, wallet information 132, settlement information 133, or the like as necessary.

The short-range wireless communication unit 34 has a communication function conforming to the standards such as near field communication (NFC), Bluetooth (registered trademark) low energy (BLE), and infrared data association (IrDA). For example, when making electronic money settlement, the user terminal 3 performs short-range wireless communication with the shop terminal 4 through the short-range wireless communication unit 34.

The operation/display unit 35 is constituted with a touch panel display, for example, and has an input function of receiving an operation by a user's finger or a pen or the like, and a display function of displaying various types of information under the control of the display control unit 311.

The shop terminal 4 is provided in shops (member stores) where the wallet system may be used, for example. However, the shop terminal 4 may be a server that functions as a virtual shop (so-called Electronic Commerce site) opened on the Internet. The shop terminal 4 includes a control unit 41, a communication unit 42, a storage unit 43, and a short-range wireless communication unit 44. The control unit 41, the communication unit 42, the storage unit 43, and the short-range wireless communication unit 44 are physically similar to the control unit 11, the communication unit 12, the storage unit 13, and the short-range wireless communication unit 34.

Hereinafter, the display control performed by the display control unit 311 on the operation/display unit 35 in the wallet system including the wallet server 1 according to the present embodiment will be described with reference to FIGS. 4 and 5.

FIG. 4 illustrates an example of the settlement method selection screen 35a displayed on the operation/display unit 35 by the display control unit 311. The figure illustrates an example of the settlement method selection screen 35a in a case where “A Pay”, “B Pay”, “C Pay”, and “D Pay” are registered as settlement methods. Specifically, the settlement method selection screen 35a includes settlement icons 351 to 354 displayed in a list, and a menu switching region 355. The settlement method selection screen 35a is a screen displayed when a wallet application is opened, for example.

The settlement icons 351 to 354 provide regions for displaying settlement methods, and receive a request for selecting the displayed settlement method. The display control unit 311 controls to display, in the settlement icon 351, a settlement name 351a indicating the name of the settlement method that may be used on the user terminal 3, a settlement phrase 351b explicitly indicating that settlement is to be performed by the settlement method, and a settlement information region 351c that displays additional information related to each of the settlement methods.

Specifically, the settlement icon 351 displays a mark (logo mark, acceptance mark, or the like) including the name of “A Pay” as the settlement name 351a, displays texts of “Pay with A Pay” as the settlement phrase 351b, and displays campaign information as a service related to “A Pay” as the settlement information region 351c. The settlement icons 352 to 354 also display the name of the settlement method, the mark indicating the settlement method, the settlement phrase, additional information, or the like, and these icons are functionally similar to the settlement icon 351.

Here, it is assumed that, in FIG. 4, the user has selected one of the settlement icons (settlement icons 351 to 354) of “A Pay” to “D Pay” and has performed an operation input. In response to this, the control unit 11 extracts target facilities located on the route to the destination, and outputs, onto the display, a target facility that allows the use of the settlement method selected by the user's input from among the extracted target facilities. The target facility is a shop that is provided with the shop terminal 4 capable of making a settlement by the selected settlement method.

FIG. 5 illustrates an example of the target facility display screen 35b displayed on the operation/display unit 35 by the display control unit 311. The figure displays a route R from a current location C to a destination D in a target facility display region 356, and further displays the target facility location 356a, which is a location of the target facility on the route R where the settlement method selected in FIG. 4 may be used. This results in giving the user the knowledge about the location of the target facility on the route R where the selected settlement method may be used. For example, even when there are few target facilities (shops, or the like) that may use the selected settlement method, the user may easily obtain the knowledge about the location of the target facility on the route R where the selected settlement method may be used. Furthermore, even when the region around the destination D has few target facilities such as shops, the user may obtain the knowledge about the location of the target facility on the route R where the selected settlement method may be used, and may purchase necessary products before arriving at the destination D. Furthermore, having the knowledge about the location of the target facility on the route R, the user may visit the desired target facility without making a detour or a stop-by. According to the embodiment as described above, it is possible to enhance the convenience of the wallet system.

Furthermore, the control unit 11 may output the target facility closest to the destination D to the display. This results in giving the user the knowledge about the location of the target facility closest to the destination D on the route R where the selected settlement method may be used. Specifically, the user may purchase the necessary products by using the selected settlement method at the convenience store, which is the target facility closest to the destination D being a ski resort, for example, making it possible to enhance the convenience of the wallet system.

Furthermore, the control unit 11 may output to the display the target facility whose distance to the next target facility is greater than a threshold on the route R to the destination D. This results in giving the user the knowledge about the location of the target facility having a long positional interval to the next target facility on the route R. Specifically, for example, the user may obtain the knowledge about the location of a gas station having a long positional interval to the next gas station (target facility) on the route R, making it possible to enhance the convenience of the wallet system.

Furthermore, the control unit 11 may output a target facility of an attribute based on the input of the user, to the display. Specifically, the user may visit the target facility of the attribute arbitrarily selected and input by the user, such as a convenience store, a gas station, or a bank, making it possible to enhance the convenience of the wallet system.

Furthermore, the control unit 11 may output the target facility based on the attribute of the destination D, to the display. Specifically, when the attribute of destination D is a campsite, the user may obtain the knowledge about the location of a home depot (target facility) where products necessary for camping such as firewood and charcoal may be purchased, for example, making it possible to enhance the convenience of the wallet system.

Furthermore, the control unit 11 may output, onto the display, target facilities that match a condition that the number of the target facilities located within a predetermined range from the destination D is a threshold or less. Specifically, in a case where the target facility is few (threshold is small) or none (threshold is zero) in the vicinity of the destination D, the user may drop by the target facility in the middle of the route R, making it possible to enhance the convenience of the wallet system.

Furthermore, when the distance from the destination D to the target facility having a predetermined attribute is a threshold or more, the control unit 11 may output the target facility having that attribute to the display. Specifically, in a case where the attribute of the destination D is a hotel without a restaurant and there is no restaurant (target facility) within a walking distance from the destination D, the user may drop by the restaurant on the route R. In addition, for example, in a case where the attribute of destination D is a campsite and there is no home depot (target facility) where camping equipment may be purchased within a few-minute driving distance from the destination D, the user may drop by the home depot on the route R. This results in enhancement of the convenience of the wallet system.

As described above, with the settlement program, settlement system, and settlement server according to the present embodiment, it is possible to enhance the convenience of the wallet system capable of using a plurality of settlement methods. Even in a settlement server that may use one settlement method, the convenience of the settlement system may be enhanced by displaying the location of the target facility on the route R where the settlement method may be used.

Further effects and modifications may be easily derived by those skilled in the art. Accordingly, broader aspects of the disclosure are not to be limited to the particular details and representative embodiments illustrated and described above. Accordingly, various alterations and modifications may be made without departing from the spirit or scope of the general inventive concept as defined by the appended claims and their equivalents.

In the target facility display screen 35b, the target facility may be illustrated on the route R for movement by vehicle, although the target facility may be illustrated on the route R for movement on foot, by bicycle, or the like. In this case, a threshold for the distance from the destination to the target facility (distance from the destination to the target facility) may be set according to these methods of transportation.

In addition, the attribute of the target facility may be the type of store or shop such as a convenience store, a gas station, or a home depot, but it may be a store or shop where a specified product may be purchased, or a shop where a predetermined service may be provided.

In addition, a plurality of routes may be displayed on the target facility display screen 35b. In this case, the target facility may be displayed on each of the plurality of routes.

Furthermore, the position of the target facility may be displayed on the route R when one settlement method is selected from the plurality of settlement methods as illustrated in FIG. 4. Alternatively, however, the location of this target facility may be displayed when the distance to the target facility is a threshold or less.

According to the present disclosure, it is possible to enhance the convenience of a wallet system.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium on which an executable program is recorded, the program causing a processor of a computer to execute:
extracting target facilities located on a route to a destination; and
outputting, to a display, a target facility that allows use of a settlement method selected by user's input from among the extracted target facilities.

2. The non-transitory computer-readable recording medium according to claim 1, wherein the program causes the processor to execute outputting, to the display, a target facility that is closest to the destination.

3. The non-transitory computer-readable recording medium according to claim 1, wherein the program causes the processor to execute outputting, to the display, a target facility whose distance to the target facility located next is greater than a threshold, on the route to the destination.

4. The non-transitory computer-readable recording medium according to claim 1, wherein the program causes the processor to execute outputting, to the display, a target facility having an attribute according to user's input.

5. The non-transitory computer-readable recording medium according to claim 1, wherein the program causes the processor to execute outputting, to the display, a target facility based on an attribute of the destination.

6. The non-transitory computer-readable recording medium according to claim 1, wherein the program causes the processor to execute outputting, to the display, target facilities that match a condition that number of the target facilities located within a predetermined range from the destination is a threshold or less.

7. The non-transitory computer-readable recording medium according to claim 1, wherein the program causes the processor to execute outputting, to the display, a target facility having a predetermined attribute in a case where a distance from the destination to the target facility having the predetermined attribute is a threshold or more.

8. A settlement system comprising:
a settlement server comprising a first processor comprising hardware; and
a terminal comprising
a second processor comprising hardware, and
a display,
wherein the first processor is configured to
extract target facilities located on a route to a destination, and
control to the display to display a target facility that allows use of a settlement method selected by user's input from among the extracted target facilities.

9. The settlement system according to claim 8, wherein the first processor is configured to control the display to display the target facility that is closest to the destination.

10. The settlement system according to claim 8, wherein the first processor is configured to control the display to display a target facility whose distance to the target facility located next is greater than a threshold, on the route to the destination.

11. The settlement system according to claim 8, wherein the first processor is configured to control the display to display a target facility having an attribute according to user's input.

12. The settlement system according to claim 8, wherein the first processor is configured to control the display to display a target facility based on an attribute of the destination.

13. The settlement system according to claim 8, wherein the first processor is configured to control the display to display target facilities that match a condition that the number of the target facilities located within a predetermined range from the destination is a threshold or less.

14. The settlement system according to claim 8, wherein the first processor is configured to control the display to display a target facility having a predetermined attribute in a case where a distance from the destination to the target facility having the predetermined attribute is a threshold or more.

15. A settlement server comprising
a processor comprising hardware, the processor being configured to:
extract target facilities located on a route to a destination; and
control a display to display a target facility that allows use of a settlement method selected by user's input from among the extracted target facilities.

16. The settlement server according to claim 15, wherein the processor is configured to control the display to display a target facility that is closest to the destination.

17. The settlement server according to claim 15, wherein the processor is configured to control the display to display a target facility whose distance to the target facility located next is greater than a threshold, on a route to the destination.

18. The settlement server according to claim 15, wherein the processor is configured to control the display to display a target facility having an attribute according to user's input.

19. The settlement server according to claim 15, wherein the processor is configured to control the display to display a target facility based on an attribute of the destination.

20. The settlement server according to claim 15, wherein the processor is configured to control the display to display target facilities that match a condition that the number of the target facilities located within a predetermined range from the destination is a threshold or less.
